(19) United States
(12) Patent Application Publication
(10) Pub. No.: US 2019/0014475 A1
(43) Pub. Date: Jan. 10, 2019

(54) Electronic Device Connection Method

(71) Applicant: Legrand Electric Limited, Birmingham (GB)

(72) Inventors: Paul Mans, London (GB); Merlin Milner, London (GB)

(73) Assignee: Legrand Electric Limited, Birmingham, OT (GB)

(21) Appl. No.: 15/748,718

(22) PCT Filed: Aug. 1, 2016
(86) PCT No.: PCT/GB2016/052368

§ 371 Date: Jan. 30, 2018

(30) Foreign Application Priority Data
Jul. 31, 2015 (GB) 1513599.9

(51) Int. Cl. H04W 12/08; G08C 17/00; H04L 29/06; H04W 12/04; H04W 12/06; H05B 37/02

(52) U.S. Cl. CPC H04W 12/08; G08C 17/00; H04L 63/0853; G08C 2201/20; H04W 12/06; H05B 37/0272; H04W 12/04

(57) ABSTRACT

A method for authorising the wireless connection of a first electronic device with a second electronic device for use in a lighting control system comprises the first electronic device 10 receiving a request to authorise wireless connection between the first electronic device 10 and the second electronic device 14. The first electronic device determines the presence of a third electronic device 12, and the first electronic device accepts the request only if the third electronic device is determined to be present.

This invention relates to a method and apparatus for connecting electronic devices.

### BACKGROUND

To enable wireless devices to communicate with each other, pairing two or more devices together is often necessary. One such pairing process involves putting each device into a pairing mode, typically using a button press on each unit. Once pressed, one device sends out a specific wireless message which is picked up by any other devices also in a pairing mode. This message allows them to establish communications, and remember that they are now paired. Other wireless devices in the vicinity that are not paired will not be able to participate in the communications. An example of such pairing is the WPS (Wi-fi protected setup) push button method employed on most wireless routers. The method is also used extensively on thermostat systems, where a temperature sensor is paired to a receiver next to a central heating boiler.

Whilst existing pairing methods work well in secure environments (such as the home) there is a security risk in environments with multiple occupants or visitors, for example offices, schools or public buildings. In these environments it is possible for a miscreant to pair to a device and take control of the system. For example, in the case of a lighting control system it would be possible to separately buy a control device, enter the building and pair to a light switch. The miscreant could then take control of the lighting.

The present invention seeks to provide at least an alternative to pairing methods and systems of the prior art.

### BRIEF SUMMARY OF THE DISCLOSURE

In accordance with the present invention there is provided a method for authorising the wireless connection of a first electronic device with a second electronic device for use in a lighting control system. The method comprises the first electronic device receiving a request to authorise wireless connection between the first electronic device and the second electronic device, the first electronic device determining the presence of a third electronic device, and the first electronic device accepting the request only if the third electronic device is determined to be present.

Thus, in accordance with the present invention, unauthorised connection to the electronic devices of a lighting control system is prevented by the use of a further electronic device which must be present in order for connection to be allowed.

The first electronic device determining that the third electronic device is present may comprise the first electronic device determining that the third electronic device is in wireless communication directly or indirectly with the first electronic device. For example, the first electronic device may receive an authorisation code from the third electronic device.

The request may be a pairing request to pair the first electronic device with the second electronic device.

The wireless connection may be a Bluetooth connection, a WiFi connection or a proprietary wireless protocol, for example.

The third electronic device may be a portable, battery-operated device. In this way, the third electronic device may be carried by a maintenance worker, for example.

The invention extends to an electronic device for use in a lighting control system, the electronic device being configured to operate as the first electronic device in the method of the invention. The first electronic device may be an electronic device in a network. In some embodiments, the first electronic device may be a network controller. The first electronic device may comprise a lighting controller in a lighting control system. The second electronic device may be a further lighting unit, a further sensor unit or a further light switch, for example.

The invention further extends to a computer readable non-transitory storage medium comprising instructions which, when executed in an electronic device, cause the electronic device to operate in as the electronic device of the invention.

### BRIEF DESCRIPTION OF THE DRAWINGS

Embodiments of the invention are further described hereinafter with reference to the accompanying drawings, in which:

FIG. 1 is an illustration of a representation of a lighting control system according to one embodiment of an aspect of the present invention.

### DETAILED DESCRIPTION

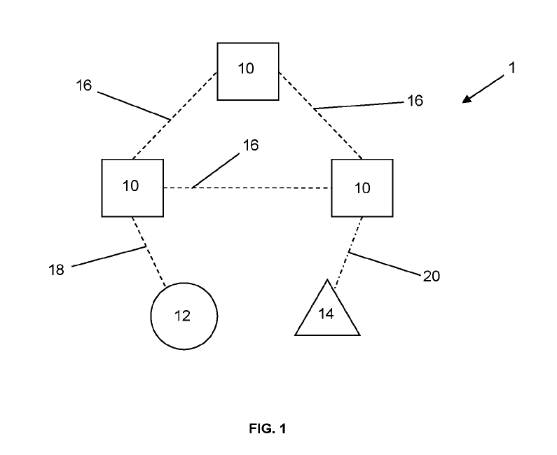

FIG. 1 is a representation of a lighting control system 1 according to one embodiment of an aspect of the present invention. The lighting control system comprises a plurality of electronic devices 10, each of which is in data communication with at least one other electronic device 10 via a data connection 16. The electronic devices 10 may be, for example, light switches, presence/absence sensors, light level sensors or lighting controllers.

Typically, the data connections 16 are wireless data connections, although it is possible for the lighting control system 1 to include electronic devices 10 that are mutually connected with wired data connections. The wireless data connections 16 utilise a protocol, such as a Bluetooth or a proprietary wireless communication protocol, according to which the electronic devices 10 are “paired” in order to authorise the establishment of a wireless data connection 16 between the devices. According to the pairing process, the two electronic devices 10 to be connected are placed in a pairing mode in which they will accept a wireless data connection request from another electronic device 10. On acceptance of such a request, the two electronic devices 10 exchange identifying information, which each device 10 stores. Subsequently, a wireless data connection 16 can be established between the two paired electronic devices 10 without repeating the pairing process, because each electronic device recognises the identifying information of the other as a device for which a wireless data connection 16 is authorised by virtue of the initial pairing process.

The electronic devices 10 form a peer-to-peer network via the wireless data connections 16. Data communications from one electronic device 10 to another in the network are preceded by a local code, which identifies the network within which the electronic devices 10 are operating. Once an electronic device 10 is connected to the network, it receives and stores the local code for the network and is programmed only to accept data communications which include the local code. The local code is generated by the first electronic device 10 in the network, i.e., the first electronic device 10 to which a second electronic device 10 connects.

As shown in FIG. 1, the network also includes a security device 12. The role of the security device 12 is to prevent unauthorised connection of electronic devices into the network. In the example shown in FIG. 1, a further electronic device 14 is attempting to pair with an electronic device 10 of the network. Each electronic device 10, once connected to the network, is configured to pair successfully with a further electronic device 14 only when the security device 12 is present. The security device 12 is a portable, for example handheld, device which can be brought into the vicinity of the network of electronic devices 10 when it is required for a further electronic device 14 to be connected to the network. In the absence of the security device 12, the electronic devices 10 of the network will not pair with an additional electronic device 14, which therefore cannot be added to the network.

In an initial configuration of the network, before the introduction of the security device 12, the electronic devices 10 will accept pairing requests from other electronic devices in the manner known from the prior art. When the security device 12 is first introduced to the network, it is paired with at least on electronic device 10 of the network and establishes a wireless (or wired) data connection 18 with the electronic device 10. The security device 12 receives the local code from the electronic device 10 to which it is connected. The security device 12 then shares with each electronic device 10 on the network a unique, factory-generated pairing code, which is stored by each electronic device 10. Subsequently, when an electronic device 10 receives a pairing request from a further electronic device 14, the electronic device 10 requests a pairing code from the security device 12 via the network. If the security device 12 is present in the network, it responds to the request for a pairing code by sending the originally-shared pairing code to the requesting electronic device 10. The requesting electronic device 10 receives the pairing code from the security device 12 and compares it to the stored pairing code. If the pairing codes match, the electronic device 10 will accept the pairing request from the further electronic device 14, which will then be authorised to join the network. Once the further electronic device 14 has successfully established a new wireless data connection 20 to the network, it receives and stores the local code and the pairing code, so that it can operate in the same manner as the other electronic devices 10 of the network.

In the absence of the security device 12, a request for a pairing code from an electronic device 10 that has received a pairing request will go unanswered. Consequently, the electronic device will not accept the pairing request and a further electronic device 14 will not be able to join the network. Similarly, if the pairing code received by the electronic device 10 does not match the stored pairing code, the electronic device 10 will not accept the pairing request and a further electronic device 14 will not be able to join the network.

It is possible that the security device 12 may be lost, in which case it would not be possible to add further electronic devices 14 to the network. To deal with this potential problem, a master security device is provided. The master security device has stored therein a pairing code and a common master code that is understood by all electronic devices 10 in the lighting control system as an alternative to the local code for validating data communications on the network. When the master security device attempts to connect to an electronic device 10 of the network, it sends the master code and a pairing code to the electronic device 10. The electronic device 10 recognises the communication from the master security device 12 by virtue of the inclusion of the master code in the data communication. The electronic device 10 on receiving the master code stores the new pairing code and communicates the new pairing code to the other electronic devices 10 on the network. The electronic device 10 also communicates the local code for the network to the master security device. The master security device stores the local code for the network and subsequently operates only as a normal security device 12 for the network. In this way, the master security device only works once. This is important, because if a master security device gets into the wrong hands, it can only disrupt the network once.

The security device 12 may be a personal device designed to be in the possession of a lighting control system programmer or maintainer. For example, the security device 12 may be a mobile phone or tablet computer configured to operate as described. In one embodiment, the security device 12 is a handheld, battery powered device comprising an input, in the form of a push-button switch, an indicator, in the form of an LED, a communication unit, in the form of a wireless transceiver, a processor and a memory. A long press on the push-button switch turns the security device 12 on, and the LED is illuminated to signal that the security device 12 is on. The communication unit will try to communicate with any electronic devices to which the security device 12 has previously been paired, and for which the communication unit has stored a local code in the memory. In operation of the security device 12, a short press on the push-button switch enters the security device 12 into a pairing mode.

The memory of the security device 12 is able to store many local codes, and therefore, the security device 12 may act as a security device for multiple networks. Thus in a multi-room lighting control system, each room can generate its own unique local code, but only one security device 12 would be needed to ensure the security of the electronic devices of the whole building.

In some situations it may be desirable to have multiple security devices capable of authorising connection to the same network, for example where there are several users who need access to the lighting control system, either because the users work shifts, or because there are several members in the team. In this case, to add a further security device 12 to the network, the original security device 12 must be present in order to provide the required pairing code, so that the further security device 12 can connect to the network. The further security device 12 can then provide a further pairing code, which can be stored by all of the electronic devices 10 of the network in addition to the original stored pairing code. The presence of any of the connected security devices 12 will then allow the electronic devices 10 to connect to further electronic devices 14.

It may be desirable to completely reset lighting control system devices. In this case before a reset can be instigated the security device 12 (if used) will need to be present.

It will be appreciated that alternative devices to the security device described above may be used to achieve substantially the same function. For example, it may be possible to use a Bluetooth-enabled mobile device. A Bluetooth receiver incorporated in an electronic device 10 of the lighting control system, or as a separate entity in the vicinity of the electronic device, may translate wireless Bluetooth signals into signals that can be understood by the electronic devices 10. An application on the Bluetooth mobile device may then perform the same functions as the security device to allow secure connecting of the electronic devices. Only when the mobile device is in Bluetooth range of the system device will pairing occur.

Although the present disclosure relates to lighting control systems and in particular to a security device to secure the lighting control system, it will be appreciated that it is applicable to any type of system where the connection or pairing process is potentially unsecured.

In summary, a method for authorising the wireless connection of a first electronic device with a second electronic device for use in a lighting control system comprises the first electronic device 10 receiving a request to authorise wireless connection between the first electronic device 10 and the second electronic device 14. The first electronic device determines the presence of a third electronic device 12, and the first electronic device accepts the request only if the third electronic device is determined to be present.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method for authorizing the wireless connection of a first electronic device with a second electronic device for use in a lighting control system, the method comprising:
the first electronic device receiving a request to authorise wireless connection between the first electronic device and the second electronic device;
the first electronic device determining the presence of a third electronic device; and
the first electronic device accepting the request only if the third electronic device is determined to be present.

2. The method as claimed in claim 1, wherein the step of determining that the third electronic device is present includes the first electronic device determining that the third electronic device is in wireless communication directly or indirectly with the first electronic device.

3. The method as claimed in claim 1, wherein the step of determining that the third electronic device is present includes the first electronic device receiving an authorization code from the third electronic device.

4. The method as claimed in claim 1, wherein the request is a pairing request to pair the first electronic device with the second electronic device.

5. The method as claimed in claim 1, wherein the wireless connection is a Bluetooth connection or a WiFi connection.

6. The method as claimed in claim 1, wherein the third electronic device is a portable, battery-operated device.

7. An electronic device for use in a lighting control system, the electronic device being configured to operate as the first electronic device in the method of claim 1.

8. A computer readable non-transitory storage medium comprising instructions which, when executed in an electronic device, causes the electronic device to operate as the electronic device of claim 7.
